(19) United States
(12) Patent Application Publication
(10) Pub. No.: US 2003/0135496 A1
(43) Pub. Date: Jul. 17, 2003

(54) Management program, method and apparatus for business process definition

(76) Inventor: Kazuyuki Ichikawa, Sagamihara (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/233,573

(22) Filed: Sep. 4, 2002

(30) Foreign Application Priority Data
Jan. 11, 2002 (JP) 2002-004049

(51) Int. Cl. G06F 7/00

(52) U.S. Cl. 707/3

(57) ABSTRACT

When a new business process definition is registered, a business process definition registering function commands a modified portion extracting and outputting function to output items to be tested. Business process definitions are stored in a business process definition storing area. The modified portion extracting and outputting function makes a comparison between an old business process definition and the new business process definition. Then, the modified portion extracting and outputting function extracts a node and data to be influenced by a modified portion in the new business process definition, for display.

### BACKGROUND OF THE INVENTION

The present invention relates to a method for extracting a portion of difference between business process definitions for a workflow system and a program associated with the method.

In typical workflow systems, a sequence of works is defined as a business process in advance, and the statuses of the works are transitioned according to the definition. There are a lot of methods of defining a business process. To take an example, there is provided a method in which a user describes the definition of a business process by means of data in tabular form. There is also a method in which a program for processing works is associated with pictures for storage in advance, and the user defines a business process by arranging the pictures according to process steps. JP-A-8-180110 discloses a related art in which graphical business definition information is converted into a data form (execution form) interpretable by a workflow management system through a device such as a translator.

By analyzing an actual business flow such as examination of a form and payment, the user defines a business process. However, there are sometimes cases where, because a wrong business process has been undertaken, or because a business flow has been modified from the outset of operation, a modification to the definition of the business process is forced.

In order to cope with these cases, a lot of workflow systems have a function of modifying the definition of a business process. There is provided a method, for example, in which the manager of a workflow system creates a copy of a file where data on the definition of a business process is described, gives a different file name to the copy for recording, and then modifies the contents of the business process definition. There is also a workflow system in which business process definitions before and after modification are numbered in consecutive order, so that a distinction between the unmodified business process definition and the modified business process definition can be made.

Further, in a prior art, there is disclosed a technique by which, when definition of a business process is made, a setting status of attribute information associated with node information in the definition of the business process can be verified, and the result of the verification can be readily confirmed.

### SUMMARY OF THE INVENTION

The definition of a business process can be modified according to the related arts described above. However, according to the related arts, no consideration has been given to the efficiency of a test to determine whether a workflow system operates in accordance with a newly-made business process definition. The test includes determination as to whether data is broken or determination as to whether the proper results of processes executed according to the business process definition have been obtained or not. Further, according to the prior art described above, if a complex business process has been defined, or if a new business process has been defined, it often happens that determination as to where a modified portion of the newly-defined process is, where is influenced by the modification, or which node or data item should be tested cannot be readily made.

In view of the problems of the related arts described above, the present invention has been made. It is therefore the object of the present invention to provide a workflow system that can support the identification of a modified portion in a modified business process definition and the determination of an influence range caused by the modification when a business process has been modified.

In order to achieve the object described above, the present invention includes the step of extracting a modified portion of a business process definition after modification and the step of displaying an item different from the one in a business process definition before modification or an item to be tested, on the basis of the extracted modified portion.

According to the present invention, in the method of extracting a modified portion when a business process definition has been modified, a plurality of data item relation tables is stored. In each of the data item relation tables, the names of processing nodes that constitute a business process definition are associated with the data items of data to be processed at the nodes, respectively. Then, a data item relation table comparison is made. When a different data item is found as a result of the comparison, this data item is extracted as a modified data item, and a node for processing of data associated with the extracted data item is displayed, as distinguished from other nodes.

Other objects, features and advantages of the invention will become apparent from the following description of the embodiments of the invention taken in conjunction with the accompanying drawings.

### BRIEF DESCRIPTION OF THE DRAWINGS

FIG. 1 shows an overall configuration of a workflow system according to the present invention;

FIG. 2 shows a business process definition an instance control function uses for control over an instance status transition;

FIG. 3 shows a data item relation table indicating data accesses associated with respective processing nodes of a business process definition A200;

FIG. 4 shows an instance table 144;

FIG. 5 shows a newly-defined business process definition;

FIG. 6 shows a data item relation table indicating data accesses associated with respective processing nodes of a business process definition B500;

FIG. 7 shows a processing flow by a modified portion extracting and outputting function 146;

FIG. 8A shows business process definition data on a business process definition A;

FIG. 8B shows business process definition data on a business process definition B; and

FIG. 9 shows nodes and data to be influenced by the modification of a business process definition.

### DESCRIPTION OF THE EMBODIMENTS

An embodiment of the present invention will be described below with reference to accompanying drawings.

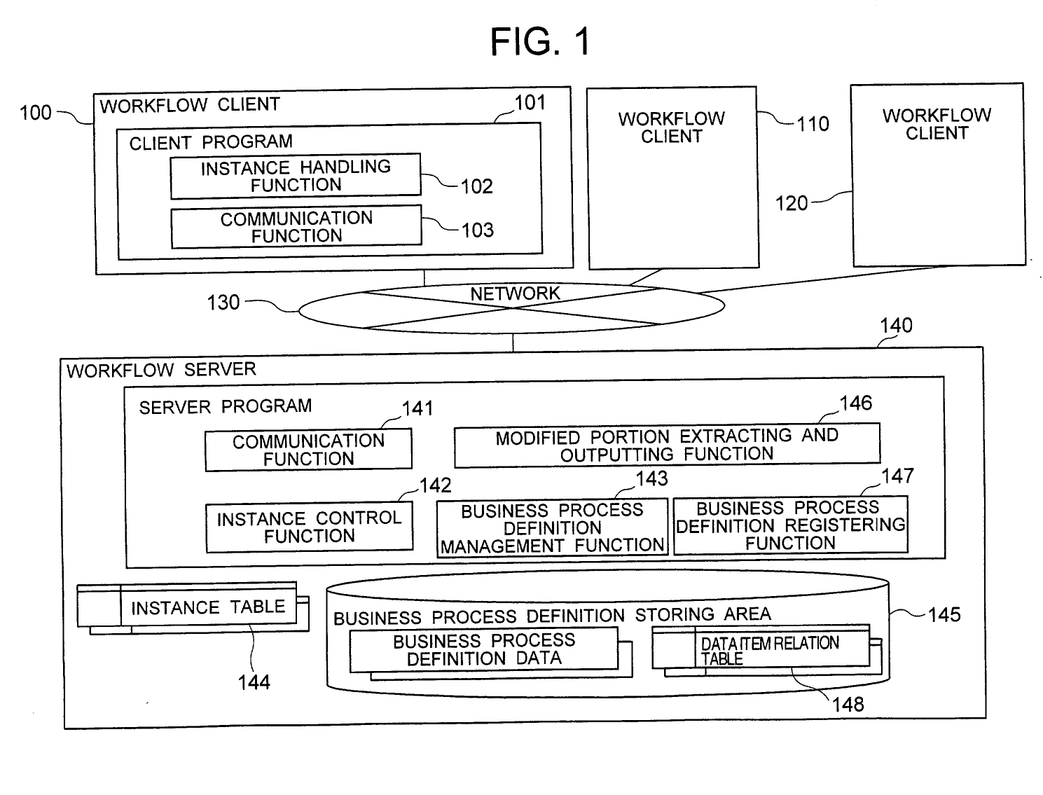

FIG. 1 shows an overall configuration of a workflow system according to the present invention. Workflow clients 100, 110, and 120 and a workflow server 140 are coupled to a network 130. The workflow clients and the workflow server are computers each having a CPU and a memory. Programs required for carrying out the embodiment are stored in the recording unit of each of the computers, for running. Further, each of the computers has hardware resources such as the recording unit, which become necessary for application of the embodiment.

The workflow client 100 includes a client program 101, an instance handling function 102, and a communication function 103. Though not shown, the workflow clients 110 and 120 also have the same functions as the workflow client 100.

The workflow server 140 has a server program that includes a communication function 141, an instance control function 142, a business process definition management function 143, a modified portion extracting and outputting function 146, and a business process definition registering function 147. The workflow server 140 further includes an instance table 144, a business process definition storing area 145, and a data item relation table 148.

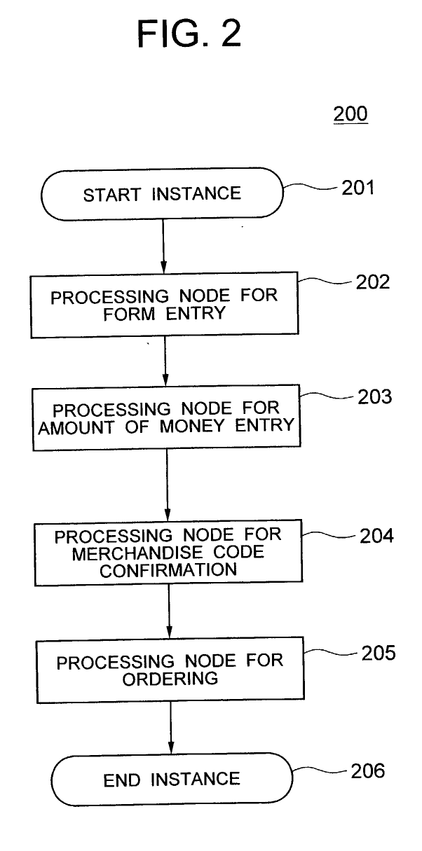

FIG. 2 shows a business process definition the instance control function 142 uses for controlling an instance status transition. A business process definition A200 shown in FIG. 2 is an example displayed on a screen on the basis of business process definition data stored in the business process definition storing area 145.

The business process definition A200 includes an instance start node 201, a processing node for form entering 202, a processing node for amount of money entry 203, a processing node for merchandise code confirmation 204, a processing node for ordering 205, and an instance finish node 206. The workflow system performs processes according to the business process definition A200. After processes for an instance is started, a workflow client performs form entry. Then, other clients perform processes of amount of money entry, merchandise code confirmation, and ordering one after another, respectively. Then, the processes for the instance are terminated. Incidentally, FIG. 2 is an example of information based on the business process definition data, displayed on the screen.

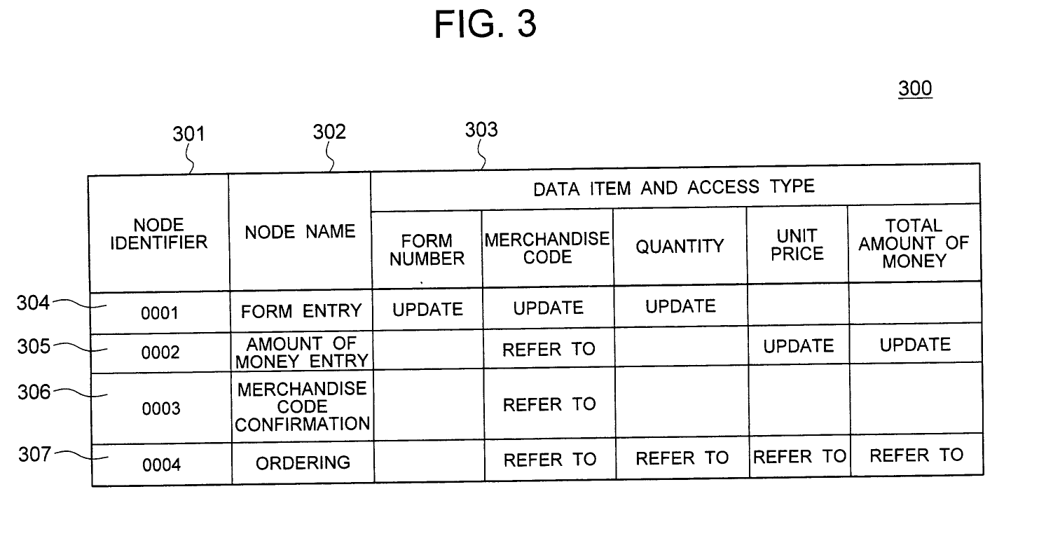

FIG. 3 shows a data item relation table showing correspondences between the respective processing nodes of the business process definition A200 and data to be processed at the respective processing nodes. The data item relation table 300 is stored in the business process definition storing area 145 together with business process definition data on the business process definition A200.

The data item relation table 300 includes a node identifier 301, a processing node name 302, and data item and access type 303. The data item and access type 303 indicate the data items of data used for performing the processes on the instance by the workflow system according to the process definition A200 and types of processing on the data indicating whether to refer to or update the data at respective processing nodes. A blank in the data item relation table indicates no update nor referring to is performed on corresponding data.

Node names in the field of the node name 302 correspond to the names of the nodes in the business process definition A200 shown in FIG. 2. The node in the business process definition A200 corresponding to a node in a field 304 of a node name form entry in FIG. 3, for example, is the processing node for form entry 202. Likewise, nodes in fields 305, 306, and 307 in FIG. 3 correspond to the processing nodes 203, 204, and 205 in FIG. 2, respectively.

The workflow client that performs the process of the processing node for form entry 202 enters a form number, a merchandise code, and the quantity of merchandise. The workflow client that performs the process of the processing node 203 refers to the merchandise code and a merchandise unit price, thereby entering a total amount of money. The workflow client that performs the process of the processing node for merchandise node confirmation 204 refers to the merchandise node. The workflow client that performs the process of the processing code for ordering 205 refers to the merchandise code, quantity, unit price, and total amount of money.

An instance herein refers to the one processed, according to a business process. Thus, data to be processed in a business process may also be regarded as an instance. Alternatively, a combination of data to be processed in a business process and other information, associated with each other may also be managed as an instance.

The business process definition A200 and the data item relation table 300 associated with the business process definition A are stored in the business process definition storing area 145, from the business process definition registering function 147 through the business process definition management function 143.

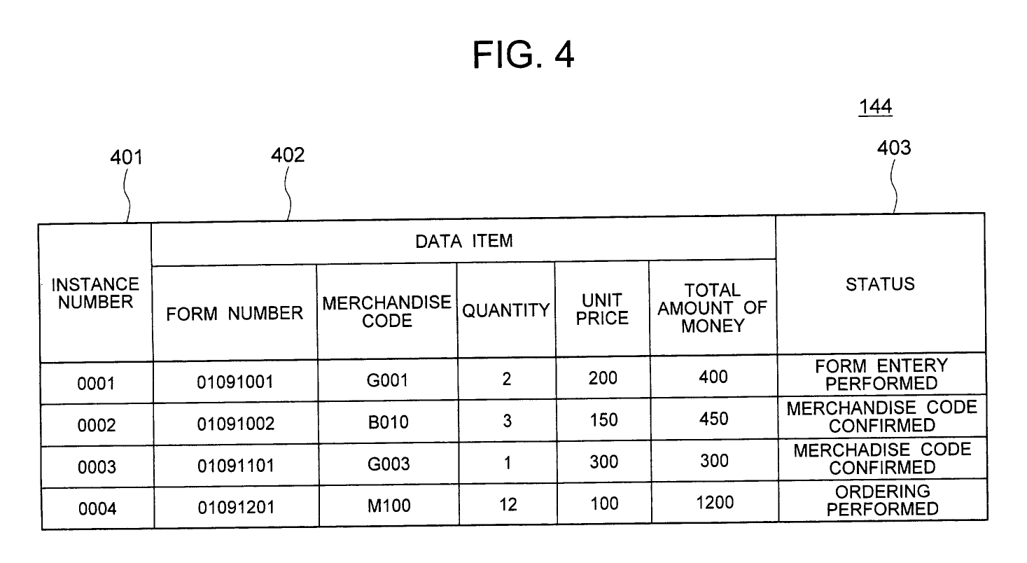

FIG. 4 shows an instance table that stores instance information. An instance table 144 includes an instance number 401, data items and data contents 402, and a status 403 indicating to which node an instance has been processed.

When an instance is processed according to a business process, a person in charge is assigned to a process included in the business process. The person in charge of the process accesses the server program using a client program, thereby obtaining information required for the assigned process and then performing the process on instance data.

The client program 101 includes functions in accordance with each of the processes in a business process definition.

Now, an example of processes by the workflow system according to the business process definition A200 will be described below.

Data for commanding to start processes is transmitted to the instance control function 142 from the communication function 103 in the client program 101 through the communication function 141 in the server program. Next, the instance control function 142, in conjunction with the business process definition management function 143, performs instance control according to the business process definition A200 based on the data from the client program 101 commanding to start the processes.

If the contents of the command issued from the client program to the server program are “user ID: A001, processing node: ordering, process content: start”, for example, it is determined whether a person in charge having the user ID A001 is assigned the process of ordering. If it is found as the result of the determination that he is the person in charge of ordering, it is determined from the instance table 144 and the business process definition A200 whether there is an instance on which the process of the node for ordering can be started. According to the business process definition A200, the business process definition management function 143 of the server program searches for data in the status to be subjected to the process at the processing node for ordering 205. Data that has been processed at the processing node for merchandise code confirmation 204 of the business process definition A200 is to be processed at the processing node for ordering 205. The instance control function 142 of the server program then searches for an instance the status 403 of which in the instance table 144 is “merchandise code confirmation”. Since it is found as the result of the search that the statuses of instances with instance numbers 0002 and 0003 are “merchandise code confirmation”, these two instances become candidates for instances to be transmitted to the workflow client. If processes are performed according to the order of instance numbers, the instance with the instance number 0002 is selected. The business process definition management function selects data representing “instance number: 0002, merchandise code: B010, quantity: 3, unit price: 150” from among data items for the selected instance number 0002 on the basis of the data item relation table 300 and transmits them to the client program 101 through the communication function 141. Since the types of accesses to the data items in the field for a node identifier for ordering 307 are “refer to”, the data for transmission is transmitted in the form of a file dedicated solely for reading. Then, data representing “instance number:0002, status: completion of ordering” is received from the workflow client that has finished the ordering process. Then, the status of the instance with the instance number 0002 is changed from “ordering” to “instance completion”, based on the result of the reception.

Incidentally, instead of transmitting the data to the client program, it may be so arranged that a Web server is connected to the workflow system, and that instance data is thereby processed by a person in charge of the process by using a browser.

Now, a description will be directed to the case where due to a modification of the contents of a business, the need for modifying the business process definition A200 has arisen.

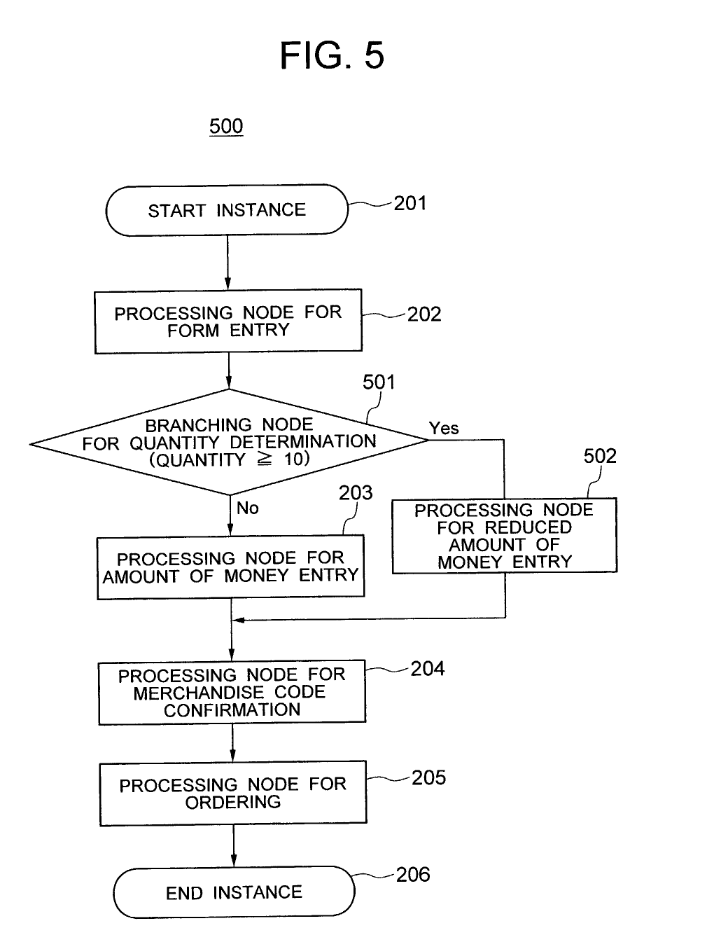

FIG. 5 shows a newly-defined business process definition B500. The business process definition B500 is displayed on the basis of the business process definition data stored in the business process definition storing area 145. The business process definition B500 is defined by modifying the business process definition A200 shown in FIG. 2. Nodes with the same node names as those in FIG. 2 indicate that they remain unchanged. When defining a business process, the manager of the workflow server 140 may copy a file that stores business process definition data, assign a different name to the file, and then store the file in the business process definition storing area 145. Alternatively, new business process definition data may be generated, and then stored in the business process definition storing area 145.

Compared with the business process definition 200 shown in FIG. 2, the business process definition B500 in FIG. 5 further includes a branching node 501 and a processing node 502. In the business process definition A200, when entry into a form is performed at the processing node 202, entry of the amount of money is performed unconditionally at the processing node 203. On the other hand, the new business process definition B500 indicates that, after entry into the form has been performed at the processing node 202, if the quantity of merchandise is equal to or larger than 10, the processing node 502 for entering a reduced amount of money rather than the processing node 202 is performed.

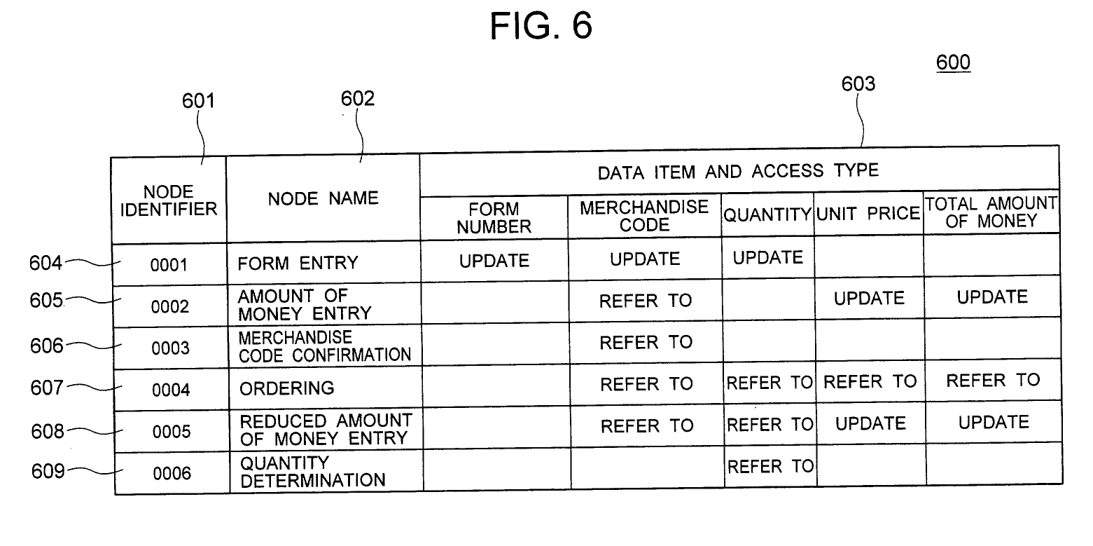

FIG. 6 shows a data item relation table indicating correspondences between data accesses and the corresponding processing nodes of the business process definition B500. Together with the business process definition B500, the data item relation table 600 is stored in the business process definition storing area 145. Like the data item relation table 300, the data item relation table 600 includes a node identifier 601, a processing node name 602, and data item and access type 603. The data item and access type 603 include data items which will be required for processes on an instance according to the business process definition B500 and information indicating whether respective data items should be referred to, updated, or remain unprocessed at each of the processing nodes.

Data items to be processed at the processing node for form entry 202 in FIG. 5 and the types of access to the data items at the processing node for form entry 202 are listed in a field 604 indicative of the data items and access types associated with a node name form entry in FIG. 6. Likewise, the processing nodes 203, 204, and 205 in FIG. 5 correspond to fields 605, 606, and 607 in FIG. 6, respectively.

In the data item relation table 600, in addition to four items listed in the data item relation table 300, the branching node for quantity determination 501 and the node for reduced amount of money entry 502 are listed. At the node for reduced amount of money entry 502, the data items of the merchandise code and the quantity are referred to, and the data items of the unit price and the total amount of money are updated.

Like the business process definition A200 and the data item relation table 300, the new business process definition B500 and the data item relation table 600 are registered through the business process definition registering function 147. In order to utilize a new business process definition, a client function for the processing node 502 added to the business process definition B500 becomes necessary. Thus, when the business process definition B500 and the data item relation table 600 are registered, an associated function is also added to the client program simultaneously.

When the new business process definition B500 and the data item relation table 600 are registered, the business process definition registering function 147 commands the modified portion extracting and outputting function 146 to extract and output the modified portion of the business process definition B500 newly defined on the basis of the business process definition A200. For execution of the command for extracting and then outputting the modified portion, it may be so arranged that historical information on a file where a plurality of business process definitions is described is stored, a file which has a version immediately before the one of a file where the registered business process definition is described is searched for, and then the searched file is compared with the file where the registered business process description is described. Alternatively, other file may also be selected for comparison with the file where the registered business process description is described.

Incidentally, the user may specify the names of a plurality of business process definitions or information indicating the business process definitions recorded in advance, and then when the user commands the computer to start the process of comparison between those data, processing by the modified portion extracting and outputting function 146 may be started. Processing by the modified portion extracting and outputting function 146 will be described below.

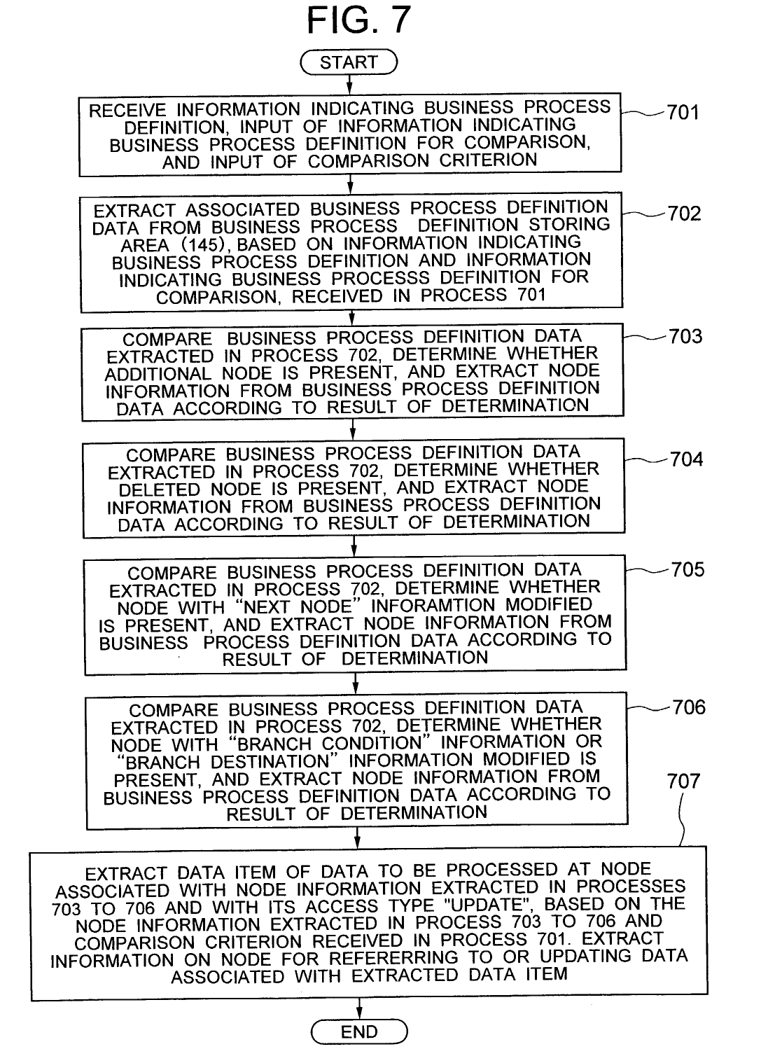

FIG. 7 is an example of a processing flow by the modified portion extracting and outputting function 146.

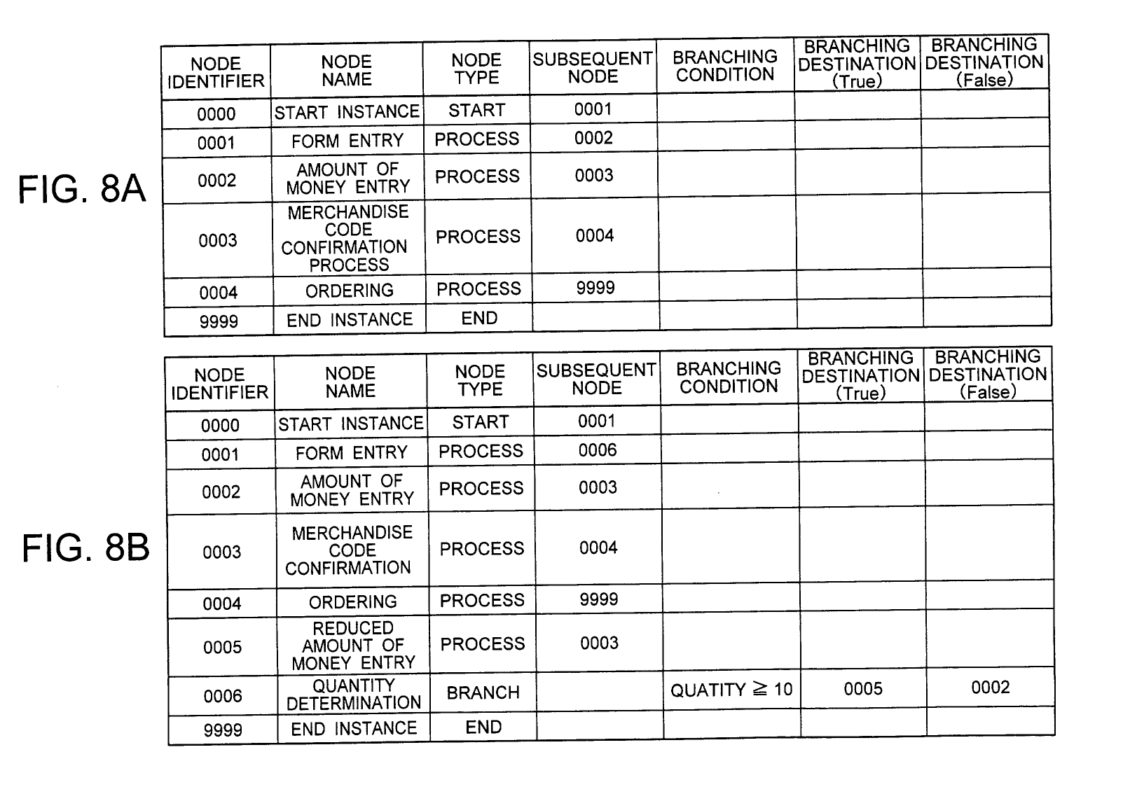

Examples of business process definition data to be subjected to this processing are shown in FIGS. 8A and 8B. As described in the description about the related art, the business process definition data may also be defined directly by the user. The business process definition data generated by the user may also be employed. For generation of the business process definition data, a tool for graphically defining an associated business process is used, and then the graphically-defined business process is converted to an interpretable form by means of a workflow server program. FIGS. 8A and 8B are just examples of business process definition data. Thus, other defining method may also be employed.

Data items of data shown in FIGS. 8A and 8B will be described. Each of the data items in FIGS. 8A and 8B indicates a “node identifier”, a “node name”, and a “node type” for each of nodes included in the business process definition. In this embodiment, the “node identifier” has a value specific to each node. In this embodiment, although the value for the “node identifier” is used as information identifying an associated node, the value for other data item may also be employed as information identifying the associated node, in place of the node identifier. By using the information identifying the associated node, a comparison between business process definition data is performed. Among the data items, a “subsequent node” indicates the node identifier of the node to be processed subsequent to a node indicated by a node identifier or a node name associated therewith. A “branching condition” in the data items indicates under what condition processing is to be branched. At a node having a node identifier 0006 in FIG. 8B, for example, a branch is performed in accordance with the result of determination whether “quantity” data is equal to or larger than 10. Thus, a branching condition of “quantity ≧10” is described. A “branching destination” in the data items indicates the identifier of a node to which processing at a branching node is to be branched. Though branching conditions of “True” and “False” are herein listed as data items, other branching conditions may also be defined.

Processes in FIG. 7 will be described below with reference to FIGS. 8A and 8B.

In step 701, entry of information indicating a business process definition and entry of information indicating a business process definition to be compared therewith are performed, and a comparison criterion is entered.

A description will be directed to the case where the name of the business process definition A as information indicating the name of the business process definition for comparison, the name of the business process definition B as the name of the business process definition, and an “additional node” as a comparison criterion are received in this process. Instead of receiving entry from the user, this information may also be stored into a recording medium that can be read by the computer, in advance.

In step 702, business process definition data associated with the entered names of the business process definition are extracted from the business process definition storing area 145.

As examples of the extracted business process definition data, the business process definition data of the business process definition A is shown in FIG. 8A, while the business process definition data of the business process definition B is shown in FIG. 8B.

In step 703, the comparison between the business process definition data extracted in the process in step 702 is performed, determination as to whether an additional node is present is made, and then information on the node is extracted according to the result of the determination. As a method of the determination, a node identifier comparison, a node name comparison, or other method may be employed.

In the examples of the data shown in FIGS. 8A and 8B, two nodes with node identifiers 0005 and 0006 are the nodes added to the data in FIG. 8A. Thus, information on these two nodes is extracted.

In step 704, a comparison between the business process definition data extracted in the process in step 702 is performed to determine whether a deleted node is present or not, and then according to the result of the determination, information on the node is extracted.

In the examples of the data in FIGS. 8A and 8B, no data is deleted from the data in FIG. 8A. Thus, in these data examples, no node information is extracted.

In step 705, a comparison between the business process definition data extracted in the process in step 702 is performed to check whether there is a node to which the node subsequent has been modified.

In the examples of the data in FIGS. 8A and 8B, a node with a node identifier 0001 satisfies the above-mentioned condition. In the data in FIG. 8A, a node subsequent to the node with the node identifier 0001 is the node with the node identifier 0002. While on the other hand, in the data in FIG. 8B, a node subsequent to the node with the node identifier 0001 is the node with the node identifier 0006. Accordingly, information on the node with the node identifier 0001 is extracted.

In step 706, a comparison between the business process definition data extracted in the process in step 702 is performed to check whether a node is present of which a branching condition or a branching destination has been modified.

In the examples of the data in FIGS. 8A and 8B, in the data of FIG. 8A, there is no information on a node having data on its branching condition or branching destination. Accordingly, there is no information to be extracted in these examples of the data.

In step 707, data items of data to be processed at the nodes associated with the node information extracted in the processes from steps 703 to 706 and with their data items and access types being “update” are extracted, on the basis of the node information extracted in the processes in steps 703 to 706 and the comparison criterion received in the process in step 701. Then, information on nodes for referring to or updating data associated with the extracted data items is extracted.

In the examples of the data in FIGS. 8A and 8B, the node information extracted in the process in step 703 is the node identifiers 0005 and 0006. No node information is extracted in the process in step 704. Node information extracted in the process in step 705 is the node identifier 0001, and no node information is extracted from the process in step 706. Since the comparison criterion received in the process in step 701 is the “additional node”, the data item and the access type of the data to be processed at the nodes with the node identifiers 0005 and 0006 extracted in the process in step 703, which is the additional node information, are extracted from the data item relation table. The data items of which the access types are “update” for the node with the node identifier 0005 are the “unit price” and the “total amount of money”. For the node with the node identifier 0006, no data items of which the access types are “update” are present.

On the basis of these data described above, information on the nodes where data listed in the data item fields of the “unit price” or “total amount of money” is referred to or updated is extracted from the data item relation table for the business process definition B. The nodes where the data in the data item fields of the “unit price” and the “total amount of money” is updated are two nodes with the node identifiers 0002 and 0005. The node where the data in the data item fields of the “unit price” or the “total money amount” is referred to is the node with the node identifier 0004. Consequently, as information on the nodes where the target data items are “updated”, the node identifiers 0002 and 0005 are extracted, and as information on the node where the target data items are referred to, the node identifier 0004 is extracted.

Incidentally, data item relation tables associated with the information indicating a business process definition and information indicating a business process definition to be compared therewith, respectively, may be extracted on the basis of the business process definition information received in the process in step 701. Then, comparisons may be performed between the respective data items in these data item relation tables for each node identifier, and a modified portion may be thereby extracted.

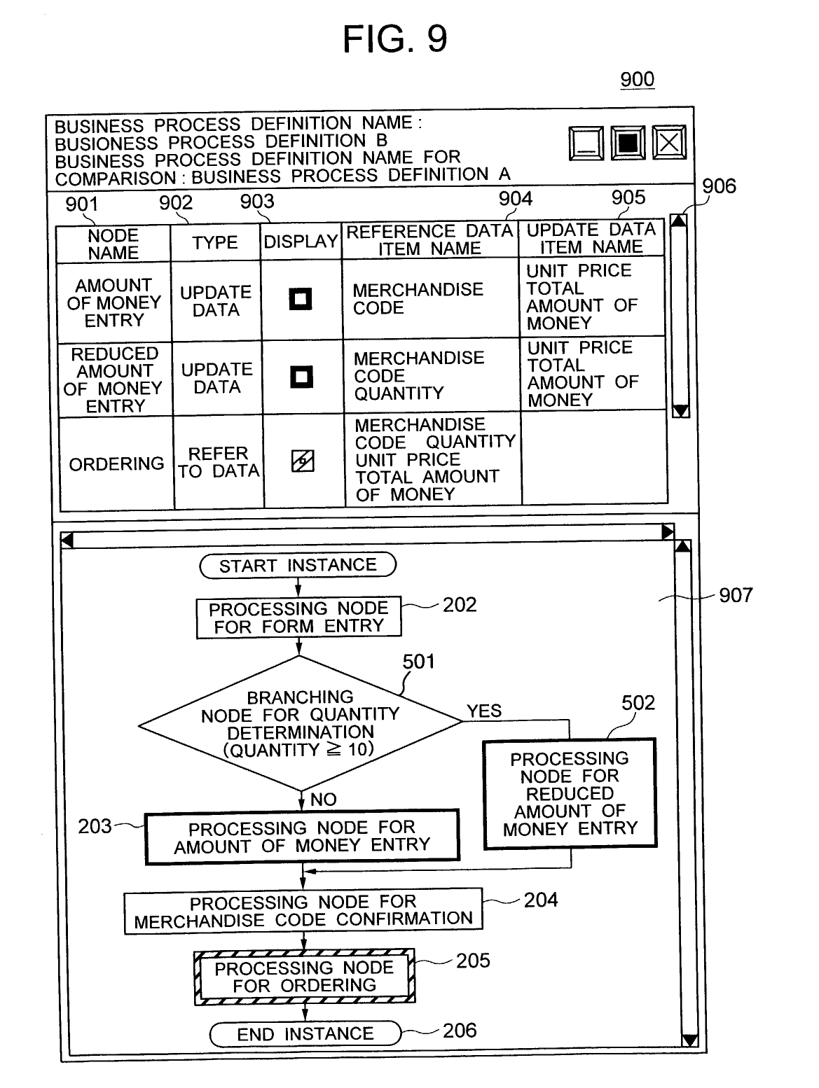

The foregoing description was directed to the processing by the modified portion extracting and outputting function 146 with reference to FIG. 7 and FIGS. 8A and 8B. FIG. 9 is an example of output performed on the basis of the information extracted by this processing.

Referring to FIG. 9, the name of the target business process definition is the “business process B”, while the name of the business process definition to be compared therewith is the “business process A”. FIG. 9 displays information on the nodes where the data to be processed at the additional nodes is updated or referred to. The access types of the data are “update”.

Though an output example on a screen was herein displayed, the output may also be printed. Alternatively, the result of extraction of data and items to be tested when a business process definition is executed may be supplied to a file. The items to be tested include the name of nodes used for the test and the types of data items to be processed at the nodes. Still alternatively, other method may also be employed.

A field 906 in FIG. 9 is a list displayed in the form of a window. In the field 906, comparisons of nodes of the business process definitions and data processing at the nodes are made between the business process definition data of the business process definition A in FIG. 8A and the business process definition data of the business process definition B in FIG. 8B, based on the processes described above. Then, the nodes to be influenced by the modification of the business process definition data are associated with data to be processed at the nodes, and they are listed in the form of the window.

A node name 901 indicates the name of a node to be influenced by the modification of a business process. A type 902 indicates what kind of modification and influence the node has been subjected to.

In this example, among data to be processed at the two additional nodes for quantity determination 501 and amount of money entry 502, the data of which the access types are “update” are data on the “unit price” and the “total amount of money”.

Accordingly, as the nodes where two data on the “unit price” and the “total amount of money” are updated, the names of the nodes for “amount of money entry” and “reduced amount of money entry” are displayed in the field for the node name 901, and the type indicating “update data” is displayed in the field for the type 902.

The name of a node where two data on the “unit price” and the “total amount of money” is referred to is the node for “ordering”. The node name of “ordering” is thus displayed in the field for the node name 901, and “refer to data” is displayed in the field for the type 902 associated with the node name.

A display 903 shows display examples when a distinction is made among display of data in a business process definition according to the type 902. In these examples, the data of which the type 902 is “update data” is displayed, being surrounded by a thick line, while the data of which the type 902 is “refer to data” is displayed, being surrounded by a diagonally shaded area. A reference data item name 904 and an update data item name 905 show a list of the names of data to be referred to or updated at each of the nodes with the node names associated with the names of the data.

As seen from the result of comparison between the business process definition A200 in FIG. 2 and the business process definition B500 in FIG. 5, the processing node 204 is the one to be executed after execution of the branching node 501 that has been added, but data to be processed at the processing node 204 is not outputted as the result of the processes described above. According to the modification of the business process definition described above, the branching node 501 is added, so that either one of the processing node 203 or 502 is to be executed. In both cases where processing is performed at either one of the processing nodes described above, the value for the merchandise code remains unchanged. These two data items of merchandise code and quantity are entered at the processing node 202 before execution of the branching node 501. Thus, even if either of them is processed at the branching node 501, the contents of data remain unchanged. The processing node 204 is the node where only a merchandise code is referred to, and data on the “total amount of money” and the “unit price” is not handled. The contents of these data change according to the modification of a business process definition. Thus, the processing node 204 is not influenced by the modification of the business process definition. For this reason, when operating the workflow system according to a newly-defined business process definition, the need for a test is low. Thus, the data to be processed at the processing node 204 is not displayed.

By outputting nodes, data, and information on the nodes and the data, to be influenced by the modification of a business process definition in the above-mentioned manner, an extent of influence caused by the modification of the business process definition can be readily recognized. Further, with this arrangement, when the test on the workflow system is carried out, which node and which data item to be tested can be efficiently determined.

A field 907 in FIG. 9 is a display in the form of a window, which illustrates nodes where data to be processed is influenced by the modification from the business process definition A to the business process definition B.

In this embodiment, the processing nodes 203 and 502, which are the nodes between the branching node 501 and the joining point, are displayed, being surrounded by the thick line.

A processing node where the data under the names of the “unit price” and the “total money amount” is referred to is the processing node 205. That is, though processing at the node is not modified, the contents of data to be processed at the node are influenced. Thus, the processing node 205 is displayed, being surrounded by the diagonally shaded area, so that it is distinguished from other node.

By displaying on a screen an additional node and a processing node where the contents of data are influenced by processing at the additional node in the above-mentioned manner, as distinguished from other nodes, as a result of comparison between different business process definitions, a difference in processing before and after the modification of a business process definition can be readily seen. Other nodes refer to nodes that are not additionally provided nor modified, and nodes where data to be processed is not influenced by the modification of a business process definition. In this embodiment, the nodes to be influenced by the modification of the business process definition are displayed as distinguished from other portions, and the nodes not to be influenced by the modification of the business process definition are displayed without alteration. Other display methods may also be employed, alternatively.

FIG. 9 is just an example of display. Thus, instead of displaying nodes by different types of surrounding lines, display may also be performed by using different colors for nodes or changing the type or size of characters for nodes. Alternatively, other display methods may also be employed. When the processing node for ordering 205 in the field 907 in FIG. 9 is clicked by a mouse, for example, items in the field 906 in FIG. 9, associated with the processing node name corresponding to the node for ordering 205 may be displayed in the form of pop-up windows. Alternatively, other display method may also be employed for association.

Further, a plurality of business process definitions may be arranged for display so as to see a difference between the business process definitions before and after a modification. In the above-mentioned embodiment, for example, the business process definition A before the modification may be displayed together with the output example shown in the field 907 in FIG. 9. In this embodiment, when displaying business process definition data on the screen, the processing nodes are displayed in the shapes of rectangles, while the branching node is displayed in the shape of a rhombus. Other display method may also be employed for representing a business process definition. To take an example, it may be so arranged that icons of the same shape are displayed on the screen, and then, by displaying node identifiers on the icons, node distinction is made.

In this embodiment, the business process definition A with the branching node 501 and the processing node 502 additionally provided is stored as the new business process definition B. Then, based on the data to be influenced by addition of the processing node, this embodiment can give a measure of the determination as to which processing node should be focused for carrying out a test on the business process definition.

The embodiment described above is just an example of carrying out the present invention. When a processing node is deleted from a certain business process definition, for example, the present invention can be applied. In this case, the deleted node may be represented by a broken line, and a list of data which will not be utilized may be displayed. Further, suppose the cases where the type of data to be processed at the nodes of a business process definition is changed from integers to decimal points or from alphanumeric characters to Japanese, with no modification made to the nodes. In these cases, the node where changed data is handled may be associated with the types of the data before and after the data change, and then they may be listed for display.

Further, this embodiment may be applied to the case where a plurality of different business process definitions is compared with one another. Alternatively, when a certain business process definition is upgraded and when a comparison is made between the business process definitions before and after the upgrade, this embodiment may also be applied.

By making a comparison between business process definitions, extracting information on a difference between the business process definitions, and then checking to see in which node process data in the extracted information is changed, in the manner described above, it can be seen which node process will be influenced by which data.

The function of this embodiment can be applied not only to the computer where the workflow server program is run but also to the computer where the workflow client program is run. This embodiment can be applied to the case where the user who uses the workflow client program processes data using a new business process definition, for example. In this case, data on a modified portion in the business process definition can be listed according to the present invention. With this arrangement, it can be checked whether processing to be performed by the user on the data items of the data is proper or not. Further, when the workflow system has been operated using a new business process definition and any error has occurred at the start of the operation, the modified portion in the new business process definition and data associated with the modified portion are displayed together with an error message, by means of the display method as described in this embodiment. In such a case, this arrangement can serve as a guide for determining by which node of or data on the business process definition the error has been caused.

The above description was directed to the case where the workflow system has only one workflow server. However, the workflow system may be configured to have a plurality of workflow servers to be operated in conjunction with one another. Further, a program for realizing this embodiment may be stored in a recording medium that is accessible via a network, and the program may be used via the network. Still further, the program may be stored in a recording medium that is readable by a computer, and the program may be installed to the computer from the recording medium, for use.

According to the present invention, the extent of influence is automatically outputted. Thus, the present invention is particularly effective when a business process definition is too long to be seen just by a visual check, such as the business process definition of a huge size having several tens or several hundreds of processing nodes. The technique according to the present invention is also effective when a check on processing cannot be made just by means of a flowchart for a business process definition. In this case, a business process definition is not modified at all, but the data to be processed at the respective nodes of the business process definition should be changed.

As described above, according to the present invention, a workflow system can be provided by which test items required for modifying a business process can be efficiently determined.

As described above, according to the present invention, information resulting from a comparison between business process definitions can be displayed in such a manner as to be readily seen.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. A program for causing a processing unit to display a business process definition stored in a recording unit of a computer, based on information on the business process definition that includes nodes defining works for a business process, the program comprising the steps of:
comparing information on a first business process definition with information on a second process definition, stored in the recording unit;
extracting information based on a difference between the information on the first business process definition and the information on the second business process definition according to a result of the comparison; and
causing the processing unit to execute a step of displaying the extracted information based on the difference.

2. The program according to claim 1, wherein the information on the business process definition includes at least one of names of the nodes, identifiers for the nodes, contents of processes at the nodes, data to be processed at the nodes, names of the data, and types of the data.

3. The program according to claim 1, wherein when the extracted information based on the difference includes one of a name of node, an identifier for the node, and contents of a process at the node, the extracted information based on the difference further includes information on a node for referring to or updating data to be updated at the node.

4. The program according to claim 1, wherein when the extracted information based on the difference includes one of data to be processed at a node in the second business process definition, a name of the data, and a type of the data, the extracted information based on the difference further includes information on a node for referring to or updating the data.

5. The program according to claim 1, wherein when displaying the extracted information based on the difference, information on a node included in the extracted information based on the difference is displayed as distinguished from nodes other than the node in the extracted information based on difference.

6. The program according to claim 1, wherein when displaying the extracted information based on the difference, information on a node common to the information on the first business process definition and the information on the second business process definition is displayed as distinguished from information on a node included in the extracted information based on the difference.

7. A method of causing a processing unit to display a business process definition stored in a recording unit of a computer, based on information on the business process definition that includes nodes for defining works for a business process, the method comprising the steps of:
storing in the recording unit a plurality of business process definitions and information on data items by the processing unit, the information on data items having names of nodes included in the plurality of business process definitions, data to be processed at the nodes, names of the data, and types of the data associated with one another;
comparing information on the nodes included in a first business process definition with information on the nodes included in a second business process definition, the first and second business process definitions being included in the plurality of business process definitions;
extracting information on a different node according to a result of the comparison;
extracting from the information on the data items a data item associated with a name of the different node included in the extracted information on the different node, based on the extracted information on the different node; and
displaying on a screen the node for processing data on the data item as distinguished from the nodes other than the node for processing the data on the data item according to a type of the data on the extracted data item.

8. The method of displaying the information on the business process definition according to claim 7, wherein the type of the data on the extracted data item includes at least information for updating or referring to the data.

9. A method of reading and then displaying a business process definition that includes nodes defining works for a business process, and data item information, stored in a computer, the data item information having names of the nodes associated with data items to be processed at the nodes and being stored as a data item relation table, the method comprising the steps of:
associating data on a plurality of business process definitions with a plurality of data item information for storage, by the processing unit;
comparing first data item information associated with identifiers indicating a first business process definition with second data item information associated with identifiers indicating a second business process definition, the first and second business process definitions being included in the plurality of business process definitions, the first data item information and the second data item information being stored as data item relation tables;
extracting information indicating a difference between the first data item information and the second data item information according to a result of the comparison, as modified data information;
extracting a name of a node for processing data in the modified data information from the data item relation table, based on the modified data information extracted; and
displaying on a screen information on the extracted name of the node as distinguished from information on names of the nodes other than the node for processing the data in the modified data information.

10. A display apparatus for causing a processing unit to display a business process definition that includes nodes defining works for a business process, stored in a recording unit of a computer, based on information on the business process definition, the apparatus comprising:
means for comparing information on a first business process information with information on a second business process information, stored in the recording unit;
means for extracting information based on a difference between the information on the first business process definition and the information on the second business process definition according to a result of the comparison; and
means for displaying the extracted information based on the difference.
